(19) United States
(12) Patent Application Publication
(10) Pub. No.: US 2026/0169461 A1
(43) Pub. Date: Jun. 18, 2026

(54) NUMERICAL CONTROL DEVICE, AND COMPUTER-READABLE STORAGE MEDIUM

(71) Applicant: Fanuc Corporation, Minamitsuru-gun, Yamanashi (JP)

(72) Inventors: Takuma OOKURA, Minamitsuru-gun, Yamanashi (JP); Kunihiro HONMA, Minamitsuru-gun, Yamanashi (JP); Tooru KUBOTA, Minamitsuru-gun, Yamanashi (JP)

(73) Assignee: Fanuc Corporation, Minamitsuru-gun, Yamanashi (JP)

(21) Appl. No.: 18/853,788

(22) PCT Filed: Apr. 12, 2022
(86) PCT No.: PCT/JP2022/017615

§ 371 Date: Oct. 3, 2024

(51) Int. Cl. G05B 19/4155

(52) U.S. Cl. CPC G05B 19/4155; G05B 2219/34029

(57) ABSTRACT

A numerical controller includes: an axis configuration storage unit that stores a plurality of axis configuration patterns indicating the axis configuration of at least one first axis belonging to a first path and at least one second axis belonging to a second path; and a setting unit that sets the axis configuration in accordance with one axis configuration pattern among the plurality of axis configuration patterns stored in the axis configuration storage unit.

### CROSS REFERENCE TO RELATED APPLICATIONS

This is the U.S. National Phase application of PCT/JP2022/017615, filed Apr. 12, 2022, the disclosure of this application being incorporated herein by reference in its entirety for all purposes.

### FIELD OF THE INVENTION

The present disclosure relates to a numerical controller and a computer readable storage medium.

### BACKGROUND OF THE INVENTION

A numerical controller that controls a plurality of paths by using machining programs that are different from each other is conventionally known. The axis configuration of a plurality of control axes respectively included in a plurality of paths is changed based on predetermined commands. For example, Patent Literature 1 discloses that a predefined command is designated in one block of a machining program used in a certain path, and thereby an axis removal setting or an axis allocation setting is performed.

### PATENT LITERATURE

Patent Literature 1: Japanese Patent Application Laid-Open No. 2010-211566

### SUMMARY OF THE INVENTION

Conventionally, however, it is possible to only perform setting of removal of one control axis or allocation of an axis in one block of a machining program. Thus, to change the axis configuration of a plurality of control axes, it is required to designate change commands for the axis configurations sequentially over a plurality of blocks, and this is a heavy burden on the operator. Thus, there is a demand for a technology to easily change the axis configuration of control axes in a plurality of paths.

A numerical controller includes: an axis configuration storage unit configured to store a plurality of axis configuration patterns each representing an axis configuration of at least one first control axis belonging to a first path and at least one second control axis belonging to a second path; and a setting unit configured to set the axis configuration in accordance with one axis configuration pattern of the plurality of axis configuration patterns stored in the axis configuration storage unit.

A computer readable storage medium stores an command that causes a computer to perform: storing a plurality of axis configuration patterns each representing an axis configuration of at least one first control axis belonging to a first path and at least one second control axis belonging to a second path; and setting the axis configuration in accordance with one axis configuration pattern of the stored plurality of axis configuration patterns.

According to one aspect of the present disclosure, the axis configuration of control axes in a plurality of paths can be easily changed.

### BRIEF DESCRIPTION OF DRAWINGS

FIG. 1 is a diagram illustrating an example of a hardware configuration of an industrial machine.

FIG. 2 is a block diagram illustrating an example of functions of a numerical controller.

FIG. 3 is a diagram illustrating an example of an axis configuration pattern stored in an axis configuration storage unit.

FIG. 4A is a diagram illustrating an example of another axis configuration pattern stored in the axis configuration storage unit.

FIG. 4B is a diagram illustrating an example of another axis configuration pattern stored in the axis configuration storage unit.

FIG. 5 is a diagram illustrating an example of a machining program.

FIG. 6 is a diagram illustrating a newly set axis configuration.

FIG. 7 is a diagram illustrating an example of a flow of processes performed in the numerical controller.

FIG. 8 is a block diagram illustrating an example of functions of a numerical controller including an operation determination unit.

FIG. 9 is a diagram illustrating an example of an axis configuration pattern.

FIG. 10 is a diagram illustrating that identification numbers are assigned to path variables.

FIG. 11 is a diagram illustrating a first axis configuration pattern.

FIG. 12 is a diagram illustrating an example of functions of a numerical controller including a pattern update unit.

FIG. 13 is a diagram illustrating an example of a machining program including an update command.

FIG. 14 is a diagram illustrating an example of the changed first axis configuration pattern.

### DETAILED DESCRIPTION OF EMBODIMENTS OF THE INVENTION

A numerical controller according to embodiments of the present disclosure will be described below with reference to the drawings. Note that not all combinations of features described in the following embodiment are necessarily required for achieving the object. Further, more detailed description than is needed may be omitted. Further, the following description of the embodiment and the drawings are provided for those skilled in the art to fully understand the present disclosure and are not intended to limit the scope of the claims.

The numerical controller is a controller that controls an industrial machine. The industrial machine is, for example, a machine tool, an electrical discharge machine, and an industrial robot. The machine tool is, for example, a machining center, a lathe, and a multi-tasking machine. The electrical discharge machine is, for example, a wire electrical discharge machine and a die-sinking electrical discharge machine. The industrial robot is, for example, a manipulator.

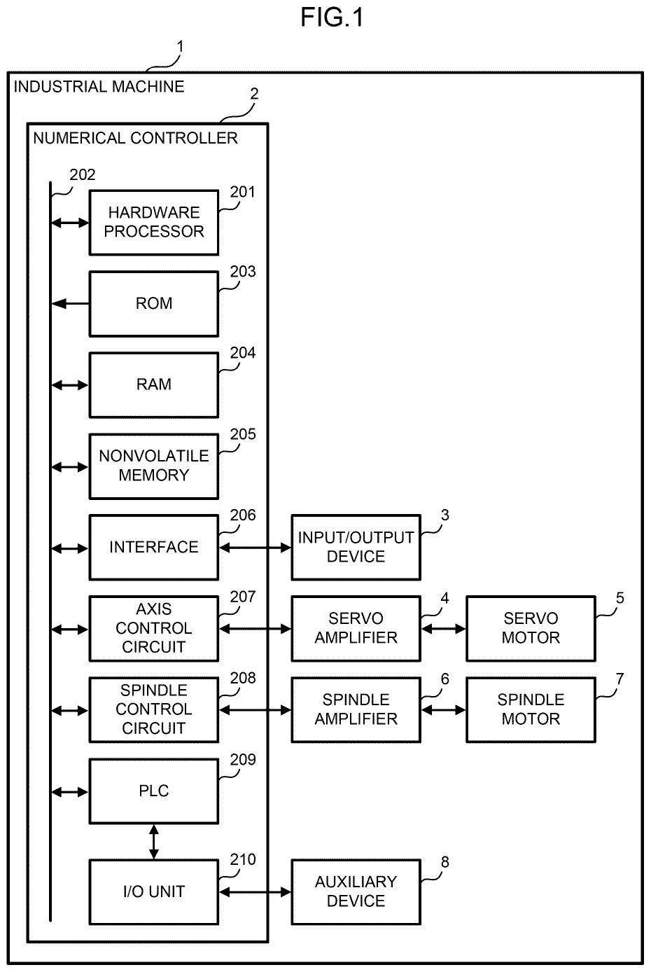

FIG. 1 is a diagram illustrating an example of a hardware configuration of an industrial machine. An industrial machine 1 includes a numerical controller 2, an input/output device 3, a servo amplifier 4, a servo motor 5, a spindle amplifier 6, a spindle motor 7, and an auxiliary device 8.

The numerical controller 2 is a controller that controls the entire industrial machine 1. The numerical controller 2 includes a hardware processor 201, a bus 202, a read only memory (ROM) 203, a random access memory (RAM) 204, and a nonvolatile memory 205.

The hardware processor 201 is a processor that controls the entire numerical controller 2 in accordance with a path program. The hardware processor 201 reads a path program or the like stored in the ROM 203 via the bus 202 and performs various processes based on the path program. The hardware processor 201 controls the servo motor 5 and the spindle motor 7 based on a machining program. The hardware processor 201 is, for example, a central processing unit (CPU) or an electronic circuit.

The hardware processor 201 performs analysis of a machining program and output of control commands to the servo motor 5 and the spindle motor 7, for example, at each control cycle.

The bus 202 is a communication path for connecting respective hardware components in the numerical controller 2 to each other. These hardware components in the numerical controller 2 transfer data to each other via the bus 202.

The ROM 203 is a storage device storing a path program for controlling the entire numerical controller 2 or the like. The ROM 203 is a computer readable storage medium.

The RAM 204 is a storage device temporarily storing various data. The RAM 204 functions as a work area for the hardware processor 201 to process various data.

The nonvolatile memory 205 is a storage device that holds data even when the industrial machine 1 is powered off and the numerical controller 2 is thus not supplied with power. For example, the nonvolatile memory 205 stores a machining program and various parameters. The nonvolatile memory 205 is a computer readable storage medium. For example, the nonvolatile memory 205 is formed of a memory backed up by a battery or a solid state drive (SSD).

The numerical controller 2 further includes an interface 206, an axis control circuit 207, a spindle control circuit 208, and a programmable logic controller (PLC) 209, and an I/O unit 210.

The interface 206 connects the bus 202 and the input/output device 3 to each other. For example, the interface 206 transmits various data processed by the hardware processor 201 to the input/output device 3.

The input/output device 3 receives various data via the interface 206 and displays the various data. Further, the input/output device 3 accepts entry of various data and transmits the various data to the hardware processor 201, for example, via the interface 206.

The input/output device 3 is a touch panel, for example. When the input/output device 3 is a touch panel, the input/output device 3 is a capacitive touch panel, for example. The touch panel may be other types of touch panels without being limited to the capacitive type. The input/output device 3 is installed to an operating panel (not illustrated) in which the numerical controller 2 is stored.

The axis control circuit 207 is a circuit that controls the servo motor 5. In response to receiving a control command from the hardware processor 201, the axis control circuit 207 transmits various commands for driving the servo motor 5 to the servo amplifier 4. For example, the axis control circuit 207 transmits a torque command for controlling the torque of the servo motor 5 to the servo amplifier 4.

In response to receiving an command from the axis control circuit 207, the servo amplifier 4 supplies current to the servo motor 5.

The servo motor 5 is driven in response to being supplied with current from the servo amplifier 4. The servo motor 5 is provided to each control axis of the industrial machine 1. When the industrial machine 1 is a machine tool having five axes, the servo motor 5 includes, for example, an X-axis servo motor, Y-axis servo motor, a Z-axis servo motor, an A-axis servo motor, and a C-axis servo motor. In such a case, the axis control circuit 207 and the servo amplifier 4 are provided to each servo motor 5, respectively.

The servo motor 5 is connected to a ball screw that drives a tool post, for example. In response to the servo motor 5 being driven, the structure of the industrial machine 1 such as a tool post moves in a predetermined control axis direction. The servo motor 5 has a built-in encoder (not illustrated) that determines the position of the control axis and the feed rate. Position feedback information and rate feedback information indicating the position of the control axis and the feed rate of the control axis, respectively, which are determined by the encoder, are fed back to the axis control circuit 207. Accordingly, the axis control circuit 207 performs feedback control of the control axis.

The spindle control circuit 208 is a circuit for controlling the spindle motor 7. In response to receiving a control command from the hardware processor 201, the spindle control circuit 208 transmits an command for driving the spindle motor 7 to the spindle amplifier 6. For example, the spindle control circuit 208 transmits a spindle rate command for controlling a rotational rate of the spindle motor 7 to the spindle amplifier 6.

In response to receiving an command from the spindle control circuit 208, the spindle amplifier 6 supplies current to the spindle motor 7.

The spindle motor 7 is driven in response to being supplied with current from the spindle amplifier 6. The spindle motor 7 is connected to the spindle and rotates the spindle.

The PLC 209 is a device that executes a ladder program to control the auxiliary device 8. The PLC 209 transmits an command to the auxiliary device 8 via the I/O unit 210.

The I/O unit 210 is an interface that connects the PLC 209 and the auxiliary device 8 to each other. The I/O unit 210 transmits an command received from the PLC 209 to the auxiliary device 8.

The auxiliary device 8 is a device installed to the industrial machine 1 and configured to perform an auxiliary operation in the industrial machine 1. The auxiliary device 8 operates based on an command received from the I/O unit 210. The auxiliary device 8 may be a device installed in the periphery of the industrial machine 1. The auxiliary device 8 is, for example, a tool exchanger, a cutting liquid injector, or an open/closure door drive device.

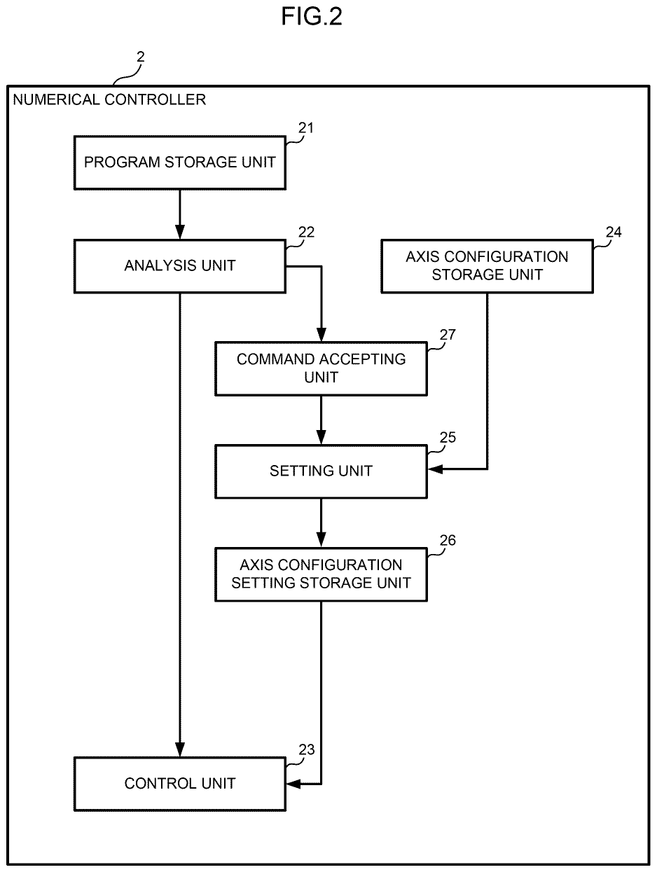

Next, functions of the numerical controller 2 will be described. FIG. 2 is a block diagram illustrating an example of functions of the numerical controller 2. The numerical controller 2 includes a program storage unit 21, an analysis unit 22, a control unit 23, an axis configuration storage unit 24, a setting unit 25, an axis configuration setting storage unit 26, and an command accepting unit 27.

The program storage unit 21, the axis configuration storage unit 24, and the axis configuration setting storage unit 26 are implemented when a machining program and various data are stored in the RAM 204 or the nonvolatile memory 205. For example, the analysis unit 22, the control unit 23, the setting unit 25, and the command accepting unit 27 are implemented when the hardware processor 201 performs computation processing by using a path program stored in the ROM 203 and various data stored in the nonvolatile memory 205.

The program storage unit 21 stores programs. For example, such a program is a machining program used for machining in a machine tool. The program may be an operation program to order an operation of a manipulator.

The analysis unit 22 reads and analyzes a program stored in the program storage unit 21. When the program is a machining program, the analysis unit 22 reads G codes, M codes, F codes, T codes, or the like described in the machining program and analyzes the meaning of each code.

The control unit 23 performs control of control axes of the industrial machine 1 based on the machining program analyzed by the analysis unit 22. When the industrial machine 1 is a machine tool, the control unit 23 performs control of the control axis, and thereby machining of a workpiece is performed.

The axis configuration storage unit 24 stores a plurality of control axis patterns representing axis configurations of control axes respectively belonging to a plurality of paths. That is, the axis configuration pattern is information indicating which control axis belongs to which path. In other words, the axis configuration pattern is information indicating control axes configuring each of the plurality of paths.

The plurality of paths includes at least a first path and a second path. At least one control axis belongs to each path. Further, the axis configuration storage unit 24 stores a plurality of axis configuration patterns. That is, the axis configuration storage unit 24 stores a plurality of axis configuration patterns representing the axis configuration of at least one first control axis belonging to the first path and at least one second control axis belonging to the second path.

The path is a group of axes controlled by a single machining program. For example, in a lathe having an upper tool post, a lower tool post, a first spindle, and a second spindle, when the upper tool post and the first spindle are controlled based on a first machining program, the upper tool post and the first spindle belong to the first path. Further, when the lower tool post and second spindle are controlled based on a second machining program, the lower tool post and the second spindle belong to the second path.

Note that the single machining program described above may include one or a plurality of subprograms. Further, the axis may include control axes such as an X-axis, a Y-axis, a Z-axis, an A-axis, a B-axis, and a C-axis and the spindle.

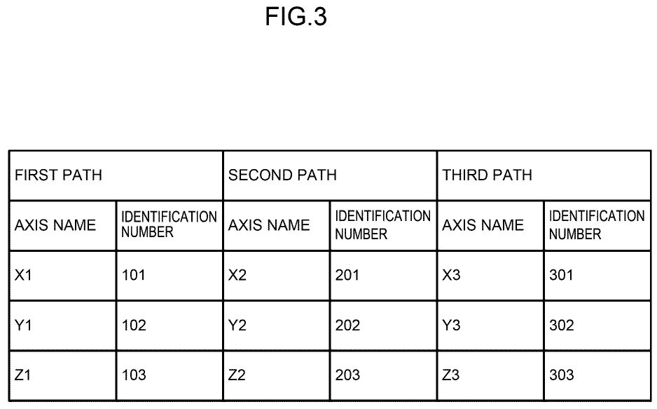

FIG. 3 is a diagram illustrating an example of the axis configuration pattern stored in the axis configuration storage unit 24. In the following, the axis configuration pattern illustrated in FIG. 3 is referred to as an initial state axis configuration pattern. The initial state refers to a state of the axis configuration that is set when the numerical controller 2 is manufactured and shipped, for example.

At least one control axis belonging to each path is identified by an axis name and an identification number. For example, the axis name is used when the control axis is designated in the machining program. The identification number is a unique number allocated to each of the plurality of control axes of an industrial machine.

For example, a plurality of paths includes a first path, a second path, and a third path. For example, control axes whose axis names are “X1”, “Y1”, and “Z1” belong to the first path. The identification numbers for “X1”, “Y1”, and “Z1” are “101”, “102”, and “103”, respectively. The last two digits of an identification number represent an axis number in a path to which a control axis belongs in the initial state. The third digit represents a number of a path to which a control axis belongs in the initial state. That is, the identification number “101” represents the 01-th control axis in the first path.

Control axes whose axis names are “X2”, “Y2”, and “Z2” belong to the second path. The identification numbers for “X2”, “Y2”, and “Z2” are “201”, “202”, and “203”, respectively. For example, the identification number “201” represents the 01-th control axis in the second path.

Control axes whose axis names are “X3”, “Y3”, and “Z3” belong to the third path. The identification numbers for “X3”, “Y3”, and “Z3” are “301”, “302”, and “303”, respectively. For example, the identification number “301” represents the 01-th control axis in the third path.

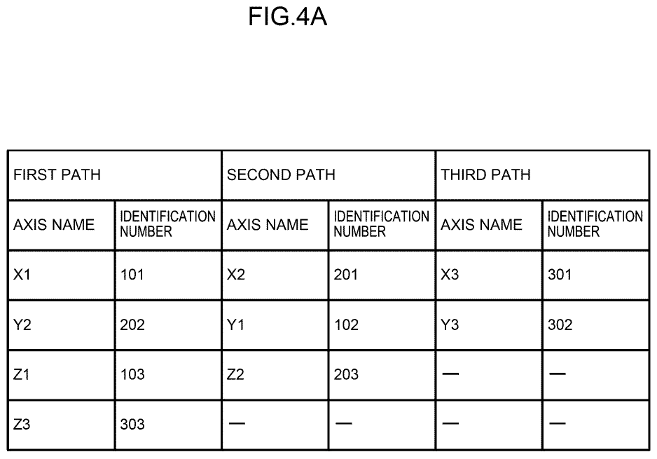

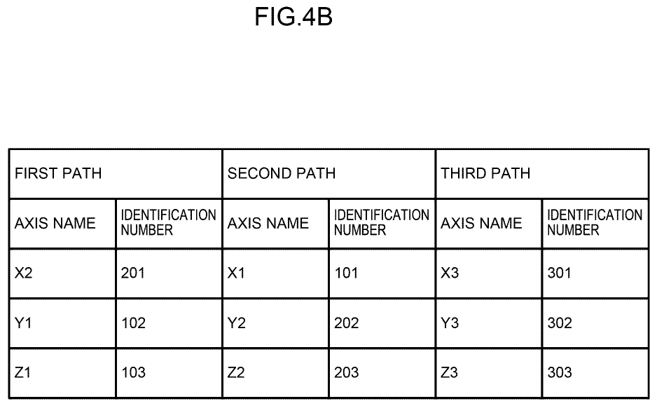

FIG. 4A and FIG. 4B are diagrams illustrating other axis configuration patterns stored in the axis configuration storage unit 24. Other axis configuration patterns are axis configuration patterns other than the initial state axis configuration pattern. In the following, the axis configuration pattern illustrated in FIG. 4A is referred to as a first axis configuration pattern, and the axis configuration pattern illustrated in FIG. 4B is referred to as a second axis configuration pattern.

The first axis configuration pattern is an axis configuration pattern in which “Y1” of the first path and “Y2” of the second path in the initial state axis configuration pattern are exchanged with each other and, further, “Z3” of the third path is moved to the first path. That is, “X1”, “Y2”, “Z1”, and “Z3” belong to the first path in the first axis configuration pattern, “X2”, “Y1”, and “Z2” belong to the second path, and “X3” and “Y3” belong to the third path.

The second axis configuration pattern is an axis configuration pattern in which “X1” of the first path and “X2” of the second path in the initial state axis configuration pattern are exchanged with each other. That is, “X2”, “Y1”, and “Z1” belong to the first path in the second axis configuration pattern, “X1”, “Y2”, and “Z2” belong to the second path, and “X3”, “Y3,” and “Z3” belong to the third path.

The setting unit 25 sets an axis configuration in accordance with one axis configuration pattern of a plurality of axis configuration patterns stored in the axis configuration storage unit 24. The setting unit 25 stores an axis configuration pattern in the axis configuration setting storage unit 26 and thereby sets the axis configuration.

The axis configuration setting storage unit 26 stores the axis configuration set by the setting unit 25. The axis configuration setting storage unit 26 maintains the set axis configuration until the axis configuration is changed by the setting unit 25.

When the numerical controller 2 is powered on, the setting unit 25 sets an axis configuration, for example, in accordance with the initial state axis configuration pattern.

The command accepting unit 27 accepts a change command that orders a change of a set axis configuration. For example, the change command is an command designated in a machining program.

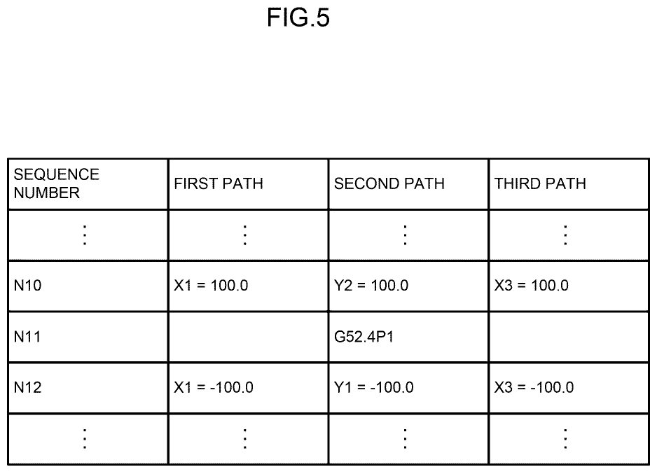

FIG. 5 is a diagram illustrating an example of a machining program. The machining program includes a machining program for the first path, a machining program for the second path, and a machining program for the third path. In the example illustrated in FIG. 5, a change command is designated in the machining program for the second path. The change command may be designated in a machining program for any path of the plurality of paths.

For example, the change command is “G52.4P1”. The part “G52.4” is a G-code to order a change of an axis configuration. The part “P” is a code to designate an axis configuration pattern. That is, “G52.4P1” is a change command to designate a change from the axis configuration that has been set in the axis configuration setting storage unit 26 to the axis configuration represented by the first axis configuration pattern.

In response to the command accepting unit 27 accepting a change command, the setting unit 25 sets an axis configuration in accordance with another axis configuration pattern different from one set axis configuration pattern. In the example illustrated in FIG. 5, the setting unit 25 changes an axis configuration illustrated in the initial state axis configuration pattern to an axis configuration illustrated in the first axis configuration pattern. That is, the setting unit 25 newly sets an axis configuration.

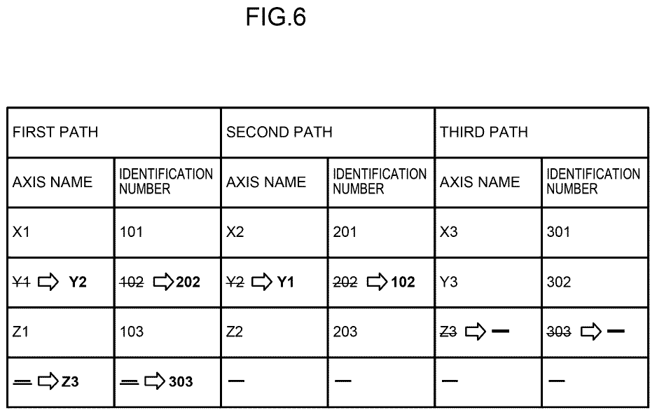

FIG. 6 is a diagram illustrating a newly set axis configuration. In the example illustrated in FIG. 6, the axis configuration represented by the initial state axis configuration pattern has been changed to the axis configuration of the first axis configuration pattern. Specifically, “Y1” belonging to the first path has been exchanged with “Y2” belonging to the second path, and “Z3” belonging to the third path has been moved to the first path.

Once an axis configuration is newly set, the control unit 23 controls each control axis based on the newly set axis configuration. In the example illustrated in FIG. 6, the control unit 23 controls the control axes whose axis names are “X1”, “Y2”, “Z1”, and “Z3” based on the machining program for the first path. Similarly, the control unit 23 controls the control axes whose axis names are “X2”, “Y1”, and “Z2” based on the machining program for the second path. Similarly, the control unit 23 controls the control axes whose axis names are “X3” and “Y3” based on the machining program for the third path.

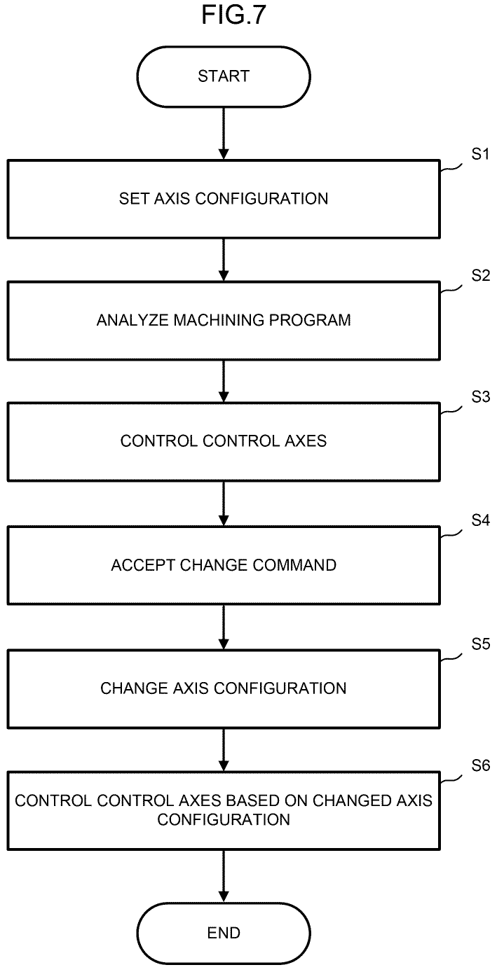

Next, a flow of processes performed by the numerical controller 2 will be described. FIG. 7 is a flowchart illustrating an example of the flow of processes performed by the numerical controller 2.

When the numerical controller 2 is powered on, the setting unit 25 sets an axis configuration in accordance with the initial state axis configuration pattern (step S1).

Next, once execution of a machining program is started, the analysis unit 22 starts analysis of the machining program (step S2).

Next, the control unit 23 controls control axes based on the machining program analyzed by the analysis unit 22 (step S3).

Next, in response to the command accepting unit 27 accepting a change command, the setting unit 25 changes the axis configuration (step S4 and step S5).

The control unit 23 then controls the control axes based on the changed axis configuration (step S6) and ends the process.

As described above, the numerical controller 2 includes the axis configuration storage unit 24 configured to store a plurality of axis configuration patterns each representing an axis configuration of at least one first control axis belonging to a first path and at least one second control axis belonging to a second path and includes the setting unit 25 configured to set an axis configuration in accordance with one axis configuration pattern of the plurality of axis configuration patterns stored in the axis configuration storage unit 24.

Therefore, the numerical controller 2 can quickly change the axis configuration of a plurality of control axes belonging to a plurality of paths. For example, even with a multi path having 10 paths, the numerical controller 2 can change the axis configuration in accordance with a change command described in one block of a machining program for any path. That is, the operator is not required to describe change commands of respective machining programs of the plurality of paths. Further, in the machining program, the operator is not required to sequentially describe a plurality of change commands that change the axis configurations of the plurality of control axes. Thus, the burden on the operator in creating a machining program can be reduced. Furthermore, occurrence of an error in creating the machining program can be reduced.

Further, the numerical controller 2 further includes an command accepting unit 27 configured to accept a change command that orders a change of the set axis configuration, and in response to the command accepting unit 27 accepting the change command, the setting unit 25 sets an axis configuration in accordance with another axis configuration pattern different from one axis configuration pattern. Herein, the change command is an command designated by a machining program. In particular, the change command is designated in one block. Thus, the processing time for the numerical controller 2 to analyze and process the change command can be reduced. As a result, the cycle time when a machining program is executed can be reduced.

The numerical controller 2 may further include an operation determination unit configured to determine whether or not at least any one of the first control axis and the second control axis is in operation. For example, the operation determination unit is implemented when the hardware processor 201 performs computation processing by using a path program stored in the ROM 203 and various data stored in the nonvolatile memory 205.

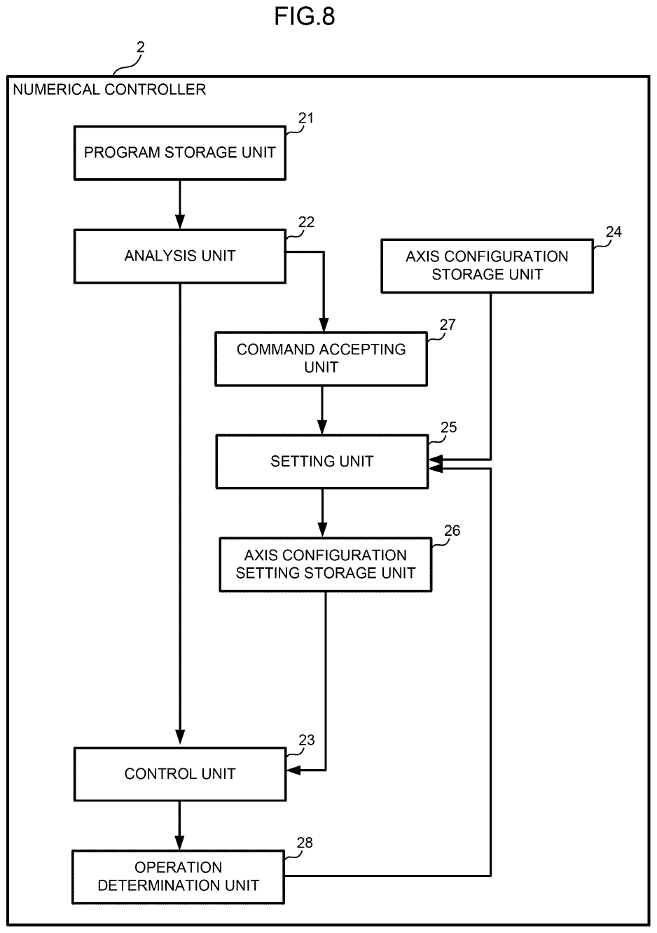

FIG. 8 is a block diagram illustrating an example of functions of the numerical controller 2 including the operation determination unit. An operation determination unit 28 determines whether or not at least any one of the first control axis and the second control axis is in operation. For example, based on an command output to the servo amplifier 4 by the control unit 23, the operation determination unit 28 determines whether or not at least any one of the first control axis and the second control axis is in operation. The operation determination unit 28 may determine whether or not at least any one of the first control axis and the second control axis is in operation based on at least any one of position feedback information and speed feedback information.

If the operation determination unit 28 determines that at least any one of the first control axis and the second control axis is in operation, the setting unit 25 cancels or suspends the change of the axis configuration. For example, when the machining program illustrated in FIG. 5 is executed, the control unit 23 suspends the execution of the change command “G52.4P1” designated by the sequence number N11 until the X1 axis is moved to 100.0 in the first path, the Y2 axis is moved to 100.0 in the second path, and the X3 axis is moved to 100.0 in the third path. In other words, the control unit 23 performs standby control until the execution of the command designated by the sequence number N10 of each path is complete.

If the operation determination unit 28 determines that neither the first control axis nor the second control axis is in operation, the setting unit 25 changes the axis configuration. In other words, if the operation determination unit 28 determines that operations of control axes belonging to each path are complete, the setting unit 25 changes the axis configuration. That is, after the operations of the first control axis and the second control axis are stopped, the setting unit 25 sets the axis configuration. This can prevent occurrence of a malfunction that would otherwise be caused by a change of the axis configuration during an operation of each control axis.

In the embodiment described above, the setting unit 25 newly sets an axis configuration based on a change command designated by one block of a machining program. However, the setting unit 25 may change the axis configuration based on a signal output in the numerical controller 2 without being limited to a change command designated in a machining program. That is, the change command may be a predefined signal. For example, when a predetermined switch on the operating panel of the numerical controller 2 is operated, such a predefined signal is output. Accordingly, the setting unit 25 can change the axis configuration in accordance with the axis configuration pattern designated by the signal.

The plurality of axis configuration patterns stored in the axis configuration storage unit 24 may include an interruption axis configuration pattern that is set when operations of the first control axis and the second control axis are interrupted. For example, the interruption means that a reset button on the operating panel is pressed and thereby a machining program ends on the way of execution.

For example, the interruption axis configuration pattern is the initial state axis configuration pattern. The interruption axis configuration pattern may be an axis configuration pattern that is set when the numerical controller 2 is powered on. The interruption axis configuration pattern may be an axis configuration pattern that has been set immediately before the interruption is made. The interruption axis configuration pattern may be any predefined axis configuration pattern.

In response to the command accepting unit 27 accepting an interruption command that orders an interruption of the operation of the first control axis and the second control axis, the setting unit 25 sets an axis configuration in accordance with the interruption axis configuration pattern.

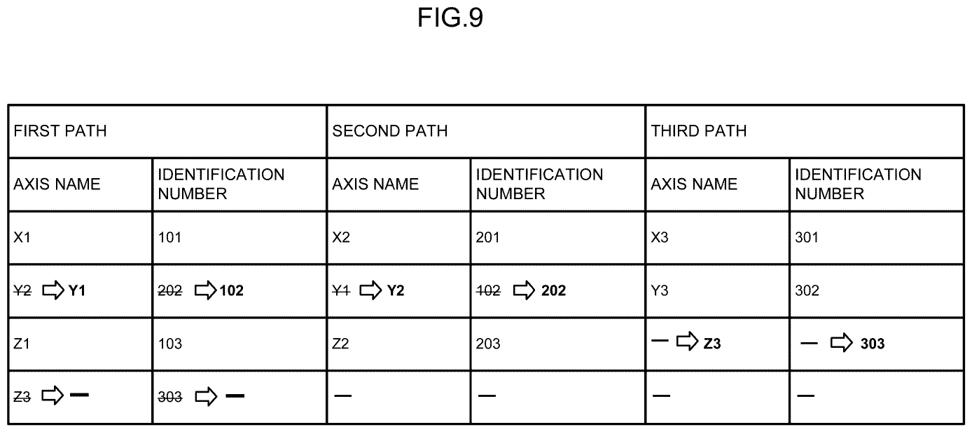

FIG. 9 is a diagram illustrating an example of an axis configuration pattern that is set in response to the command accepting unit 27 accepting an interruption command. In response to the command accepting unit 27 accepting an interruption command, the setting unit 25 sets an axis configuration, for example, in accordance with the initial state axis configuration pattern. Therefore, when the axis configuration has been set in accordance with the first axis configuration pattern, the setting unit 25 exchanges “Y2”, which has been set for the first path, with “Y1”, which has been set for the second path. Further, the setting unit 25 moves “Z3”, which has been set for the first path, to the third path.

The axis configuration storage unit 24 may store a plurality of axis configuration patterns by storing identification numbers assigned to path variables. For example, in the numerical controller 2, path variables are allocated to respective control axes of respective paths in advance, and the axis configuration storage unit 24 stores identification numbers assigned to respective path variables.

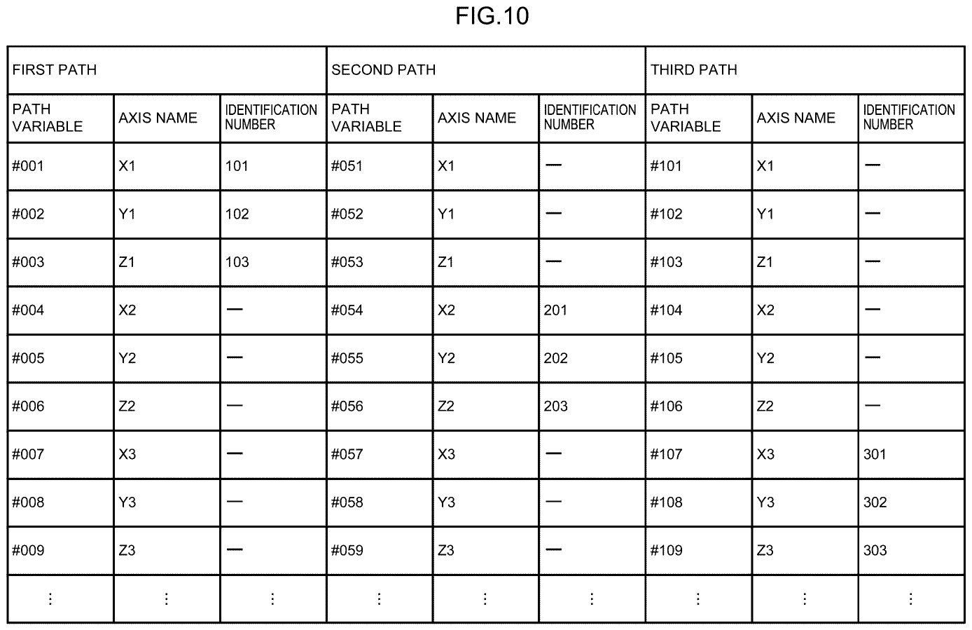

FIG. 10 is a diagram illustrating an axis configuration pattern. FIG. 10 is a diagram illustrating that identification numbers have been assigned to path variables. In the numerical controller 2, for example, path variables “#001” to “#050” are allocated to the control axes belonging to the first path. Further, path variables “#051” to “#100” are allocated to the control axes belonging to the second path. Further, path variables “#101” to “#150” are allocated to the control axes belonging to the third path.

For example, identification numbers “101” to “103” are assigned to path variables “#001” to “#003” allocated to the first path, respectively. Further, identification numbers “201” to “203” are assigned to path variables “#054” to “#056” allocated to the second path, respectively. Further, identification numbers “301” to “303” are assigned to path variables “#107” to “#109” allocated to the third path, respectively. That is, FIG. 10 illustrates the initial state axis configuration pattern.

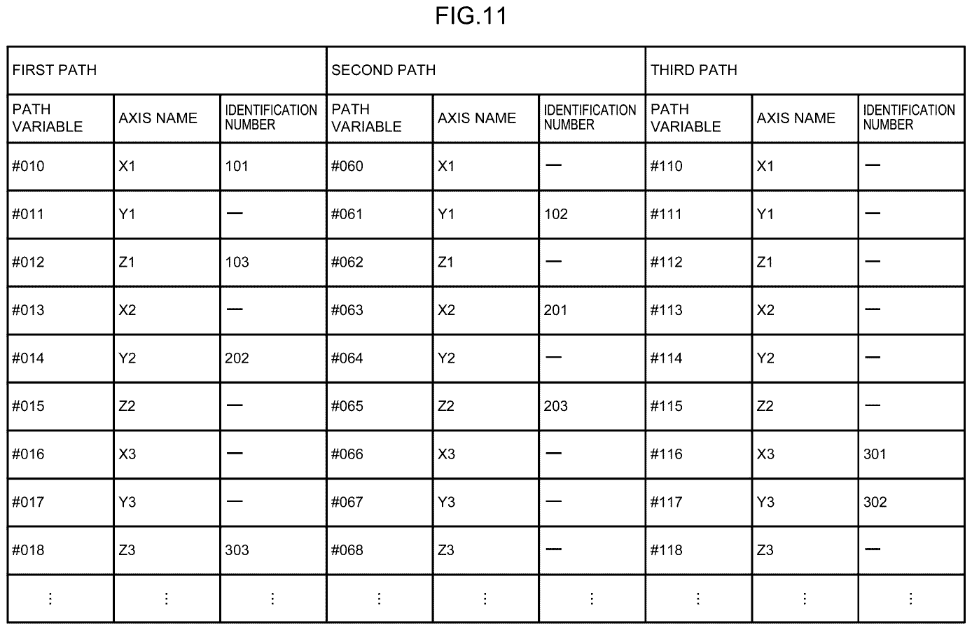

FIG. 11 is a diagram illustrating the first axis configuration pattern. Identification numbers “101”, “103”, “202”, and “303” are assigned to path variables “#010”, “#012”, “#014”, and “#018” allocated to the first path, respectively. Further, identification numbers “102”, “201”, and “203” are assigned to path variables “#061”, “#063”, and “#065” allocated to the second path, respectively. Further, identification numbers “301” and “302” are assigned to path variables “#116” and “#117” allocated to the third path, respectively. For the second axis configuration pattern, predetermined identification numbers are assigned to path variables in the same manner, though the description thereof is omitted.

The setting unit 25 reads path variables corresponding to any axis configuration pattern of the plurality of axis configuration patterns including the initial state axis configuration pattern, the first axis configuration pattern, and the second axis configuration pattern, stores the read path variables in the axis configuration setting storage unit 26, and thereby sets an axis configuration.

The numerical controller 2 may include a pattern update unit that updates any of the axis configuration patterns included in a plurality of axis configuration patterns stored in the axis configuration storage unit 24. For example, the pattern update unit is implemented when the hardware processor 201 performs computation processing by using a path program stored in the ROM 203 and various data stored in the nonvolatile memory 205.

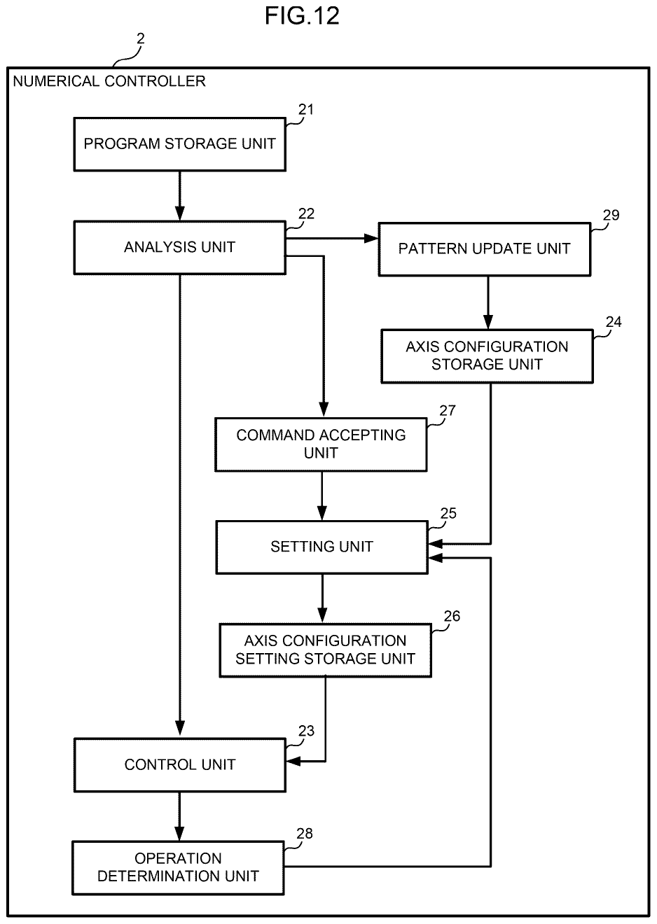

FIG. 12 is a diagram illustrating an example of functions of the numerical controller 2 including the pattern update unit. The numerical controller 2 illustrated in FIG. 12 differs from the numerical controller 2 illustrated in FIG. 8 in inclusion of a pattern update unit 29. Accordingly, the pattern update unit 29 and the function related thereto will be described here, and description of the same functions as those described with reference to FIG. 8 will be omitted.

The pattern update unit 29 updates any of the axis configuration patterns included in the plurality of axis configuration patterns stored in the axis configuration storage unit 24. For example, in response to the command accepting unit 27 accepting an update command to update an axis configuration pattern, the pattern update unit 29 updates any of the axis configuration patterns stored in the axis configuration storage unit 24.

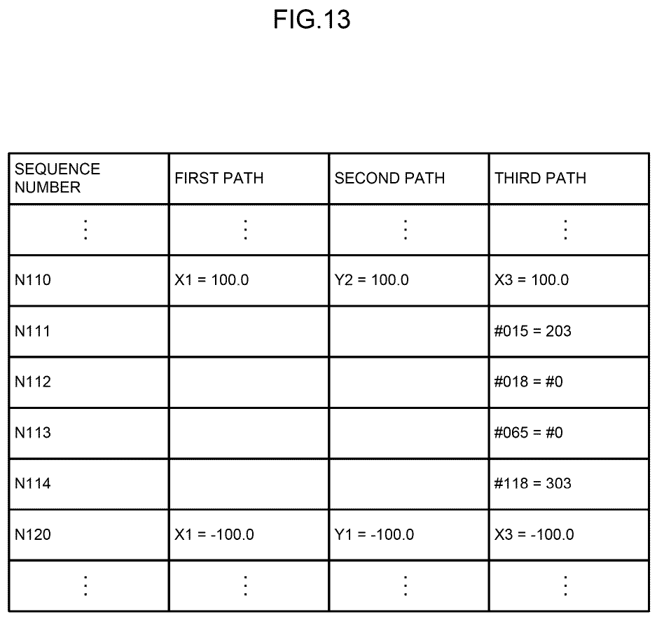

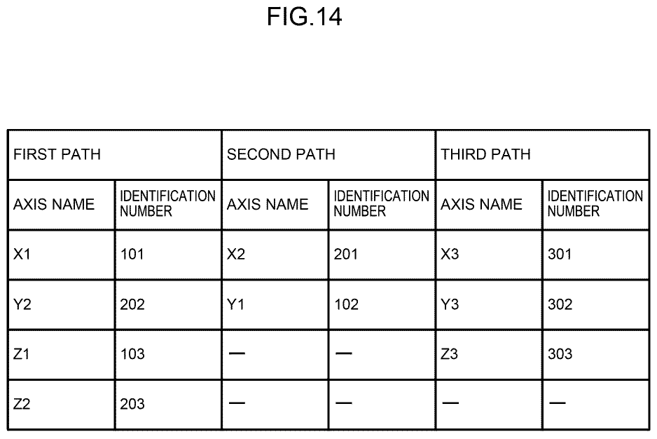

FIG. 13 is a diagram illustrating an example of a machining program including an update command. In the example illustrated in FIG. 13, in a machining program for the third path, update commands “#015=203”, “#018=#0”, “#065=#0”, and “#118=303” are designated. That is, the update command illustrated in FIG. 13 is an update command to perform update to add “Z2” to and delete “Z3” from the first path in the first axis configuration pattern illustrated in FIG. 11, to delete “Z2” of the second path, and to add “Z3” to the third path. FIG. 14 is a diagram illustrating the changed first axis configuration pattern.

Note that an update command may be designated in other ways than via a machining program. For example, an update command may be input from the operating panel. Further, when a predefined signal is output in the numerical controller 2, it may be determined that the command accepting unit 27 has accepted an update command.

Further, the numerical controller 2 may store a plurality of tables used for setting identification numbers for path variables. For example, the numerical controller 2 may read any table of the plurality of tables based on operator's operation. Accordingly, identification number sets in the table are set for path variables. As a result, a plurality of axis configuration patterns can be updated by single operation.

The present disclosure is not limited to the embodiment described above and can be changed as appropriate within the scope not departing from the spirit. In the present disclosure, modification of any component of the embodiment or omission of any component of the embodiment is possible.

[List of Reference Symbols]

| | |
|---|---|
| 1 | industrial machine |
| 2 | numerical controller |
| 201 | hardware processor |
| 202 | bus |
| 203 | ROM |
| 204 | RAM |
| 205 | nonvolatile memory |
| 206 | interface |
| 207 | axis control circuit |
| 208 | spindle control circuit |
| 209 | PLC |
| 210 | I/O unit |
| 21 | program storage unit |
| 22 | analysis unit |
| 23 | control unit |
| 24 | axis configuration storage unit |
| 25 | setting unit |
| 26 | axis configuration setting storage unit |
| 27 | command accepting unit |
| 28 | operation determination unit |
| 29 | pattern update unit |
| 3 | input/output device |
| 4 | servo amplifier |
| 5 | servo motor |
| 6 | spindle amplifier |
| 7 | spindle motor |
| 8 | auxiliary device |

1. A numerical controller comprising:
an axis configuration storage unit configured to store a plurality of axis configuration patterns each representing an axis configuration of at least one first control axis belonging to a first path and at least one second control axis belonging to a second path; and
a setting unit configured to set the axis configuration in accordance with one axis configuration pattern of the plurality of axis configuration patterns stored in the axis configuration storage unit.

2. The numerical controller according to claim 1 further comprising a command accepting unit configured to accept a change command that orders a change of the set axis configuration,
wherein in response to the command accepting unit accepting the change command, the setting unit sets the axis configuration in accordance with another axis configuration pattern different from the one axis configuration pattern.

3. The numerical controller according to claim 2 further comprising an operation determination unit configured to determine whether or not at least any one of the first control axis and the second control axis is in operation,
wherein when the operation determination unit determines that at least any one of the first control axis and the second control axis is in operation, the setting unit cancels or suspends the change of the axis configuration.

4. The numerical controller according to claim 2, wherein the change command is a command designated in a machining program.

5. The numerical controller according to claim 2, wherein the change command is a predefined signal.

6. The numerical controller according to claim 2,
wherein the plurality of axis configuration patterns includes an interruption axis configuration pattern that is set when operations of the first control axis and the second control axis are interrupted, and
wherein in response to the command accepting unit accepting an interruption command that orders an interruption of the operations of the first control axis and the second control axis, the setting unit sets the axis configuration in accordance with the interruption axis configuration pattern.

7. The numerical controller according to claim 2 further comprising a pattern update unit configured to update any one axis configuration pattern included in the plurality of axis configuration pattern stored in the axis configuration storage unit,
wherein in response to the command accepting unit accepting an update command to update the one axis configuration pattern, the pattern update unit updates the one axis configuration pattern.

8. A computer readable storage medium storing a command that causes a computer to perform:
storing a plurality of axis configuration patterns each representing an axis configuration of at least one first control axis belonging to a first path and at least one second control axis belonging to a second path; and
setting the axis configuration in accordance with one axis configuration pattern of the stored plurality of axis configuration patterns.
